(19) United States
(12) Patent Application Publication
(10) Pub. No.: US 2006/0204091 A1
(43) Pub. Date: Sep. 14, 2006

(54) SYSTEM AND METHOD FOR ANALYZING AND PROCESSING TWO-DIMENSIONAL IMAGES

(76) Inventors: Xiao-Chao Sun, Shenzhen (CN); Chih-Kuang Chang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,043

(22) Filed: Dec. 14, 2005

(30) Foreign Application Priority Data
Dec. 29, 2004 (CN) 200410091933.2

(51) Int. Cl. G06K 9/00; H04N 1/40

(52) U.S. Cl. 382/169; 358/3.01

(57) ABSTRACT

A system for analyzing and processing two-dimensional images includes a computer (1). The computer includes: an image accessing unit (11) for accessing a two-dimensional image; a parameter setting unit (12) for setting corresponding parameters needed for analyzing and processing the two-dimensional image; a gray value obtaining unit (13) for obtaining gray values of pixels of the two-dimensional image; a special pixel obtaining unit (14) for obtaining special pixels of the two-dimensional image by calculating gray grads of pixels according to respective gray values; a graph analyzing unit (15) for generating a graph according to the special pixels; and an outputting unit (16) for outputting the graph and parameters of the graph. A related method is also disclosed.

### FIELD OF THE INVENTION

The present invention relates to systems and methods for analyzing and processing images, and more particularly to a system and method for analyzing and processing two-dimensional images.

### DESCRIPTION OF RELATED ART

Along with the development of computer technology, image analyzing and processing technology has been widely used in all kinds of fields. In manufacturing, utilizing computers to examine two-dimensional images of work pieces or products can enhance the efficiency.

A two-dimensional black-and-white image is formed by many pixels, and each pixel has a gray value, which ranges from 0 to 255. Pixels of darker parts in the image have lower gray values, while pixels of brighter parts in the image have higher gray values. When contour lines appear in the image, the gray values of the pixels around the contour lines would have sharp changes. For example, the gray values may change from 80 to 120. By analyzing the change rule of gray values of pixels, we can generate graphs displayed in a two-dimensional image to analyze characteristics of the image.

However, present image analyzing and processing methods need workers to designate special pixels in a two-dimensional image, then use computers to generate graphs according to the special pixels. Because of manual participation and lower efficiency, they are not very suitable for processing mass two-dimensional images.

What is needed, therefore, is a system and method for analyzing and processing two-dimensional images with higher intellectualized degree and efficiency.

### SUMMARY OF INVENTION

A system for analyzing and processing two-dimensional images in accordance with a preferred embodiment includes a computer. The computer includes: an image accessing unit for accessing a two-dimensional image from a storage; a gray value obtaining unit for obtaining gray values of pixels of the two-dimensional image; a special pixels obtaining unit for obtaining special pixels of the two-dimensional image through calculating gray grads of pixels according to respective gray values; a graph analyzing unit for generating a graph according to the special pixels; an outputting unit for outputting the graph and parameters of the graph; and a parameter estimating unit for determining whether the parameters of the graph meet predetermined requirements.

The system for analyzing and processing two-dimensional images can further include a photography device and an image card. The photography device is used for taking photographs of an object and obtaining two-dimensional data of an object. The image card transforms the two-dimensional image data obtained by the photography device to an image which can be identified by the computer.

Another preferred embodiment provides a method for analyzing and processing two-dimensional images by utilizing the above system. The method includes the steps: (a) reading a two-dimensional image of an object from a storage; (b) obtaining gray values of pixels of the two-dimensional image; (c) calculating gray grads of the pixels to obtain special pixels of the two-dimensional image; (d) generating a graph according to the special pixels; and (e) outputting the graph and parameters of the graph.

Other advantages and novel features of the embodiments will be drawn from the following detailed description with reference to the attached drawings, in which:

### BRIEF DESCRIPTION OF DRAWINGS

FIG. 1 is a schematic diagram of hardware configuration of a system for analyzing and processing two-dimensional images according to a preferred embodiment;

FIG. 2 is a diagram of function units of a computer of the system of FIG. 1;

FIG. 3 is a flowchart of a preferred method for analyzing and processing a two-dimensional image by utilizing the system of FIG. 1;

FIG. 4 is a detailed description of one step of FIG. 3, namely obtaining gray values of various pixels of the image; and

FIG. 5 is a detailed description of another step of FIG. 3, namely obtaining special pixels of the image by calculating gray grads of corresponding pixels according to respective gray values.

### DETAILED DESCRIPTION

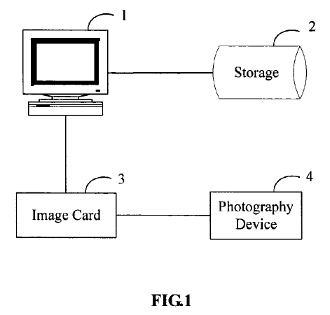

FIG. 1 is a schematic diagram of hardware configuration of a system for analyzing and processing two-dimensional images (hereinafter, “the system”) according to a preferred embodiment. The system includes a computer 1, which is typically a personal computer (PC). The computer 1 includes a plurality of units known in the art, such as a central processing unit (CPU) and a memory (not shown), for analyzing and processing the two-dimensional images. A storage 2 is connected to the computer 1, for storing the two-dimensional images and information generated by utilizing the system. A photography device 4 is connected to the computer 1 through an image card 3. The photography device 4 is typically a photo-electricity switching device that can take photographs of an object, thus to obtain two-dimensional image data of the object. The photography device 4 includes an optical sensor (not shown), which may be a Charge Coupled Device (CCD) or a Complementary Metal Oxide Semiconductor (CMOS). The image card 3 transforms the two-dimensional image data obtained by the photography device 4 to an image which can be identified by the computer 1. The image card 3 has corresponding software installed therein for data transforming, and is required to be compatible with the photography device 4.

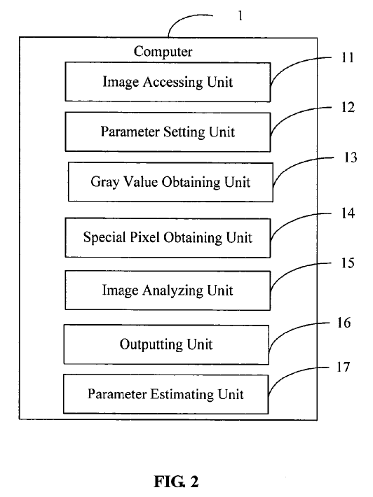

FIG. 2 is a diagram of function units of the computer 1. The computer 1 includes an image accessing unit 11, a parameter setting unit 12, a gray value obtaining unit 13, a special pixel obtaining unit 14, an image analyzing unit 15, an outputting unit 16 and a parameter estimating unit 17. The image accessing unit 11 is used for accessing a two-dimensional image from the storage 2. The parameter setting unit 12 is used for setting corresponding parameters needed for analyzing and processing the two-dimensional image, which may include the number of pixels whose gray values need to be calculated, the number of special pixels to be obtained, and so on. The gray value obtaining unit 13 is used for obtaining gray values of various pixels of the image. The special pixel obtaining unit 14 is used for obtaining special pixels of the image through calculating gray grads of corresponding pixels according to respective gray values. The image analyzing unit 15 is used for generating a graph according to the special pixels. The outputting unit 16 is used for outputting the graph and parameters of the graph. The parameter estimating unit 17 is used for determining whether the parameters of the graph meet predetermined requirements.

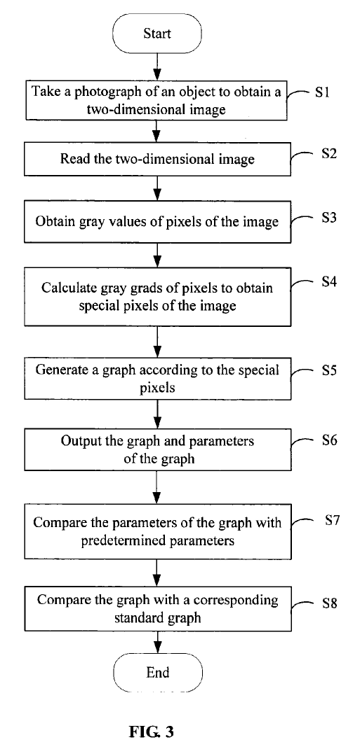

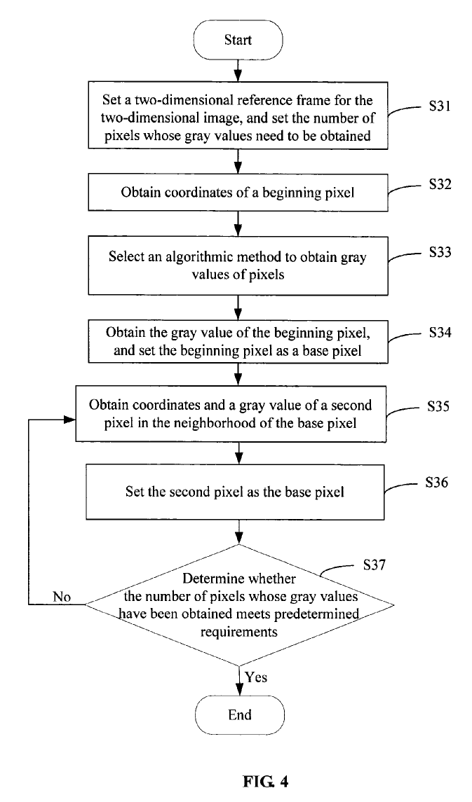

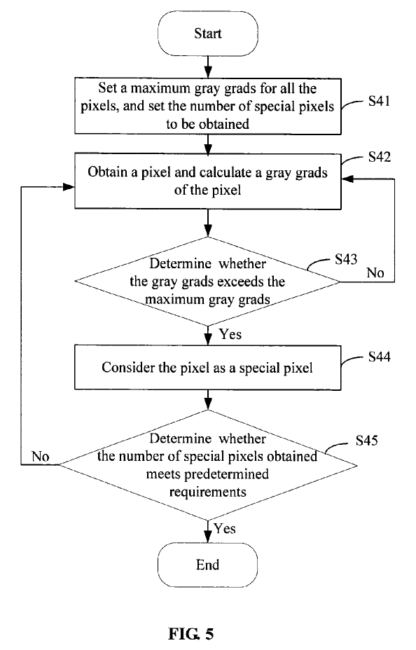

FIG. 3 is a flowchart of a preferred method for analyzing and processing a two-dimensional image by utilizing the system of FIG. 1. In step S1, the photography device 4 takes a photograph of an object to obtain a two-dimensional image of the object. The object may be a workpiece or a product. In order to obtain a clear image, the object is generally placed on a standard platform (not shown), and an appropriate photo source is adopted to illuminate the object. After the two-dimensional image of the object has been obtained, the image card 3 reads the two-dimensional image data from the photography device 4, transforms the data to an image that can be identified by the computer 1, and sends the image to the storage 2. The image may be in the format of BMP or TIF. In step S2, the image accessing unit 11 reads the image from the storage 2. In step S3, the gray value obtaining unit 13 obtains gray values of various pixels of the image (detailed description is provided in relation to FIG. 4). In step S4, the special pixel obtaining unit 14 obtains special pixels of the image through calculating gray grads of corresponding pixels according to respective gray values (detailed description is provided in relation to FIG. 5). In step S5, the image analyzing unit 15 generates a graph according to the special pixels, using corresponding geometry theorem as well as statistics mathematical formula. Taking the process of generating a beeline for example, it is well known that two points on a contour line can construct a beeline. However, the beeline constructed in this way may be greatly different from the practical beeline. To reduce the difference, more points should be obtained, and the Least Squares Method is adopted. In step S6, the outputting unit 16 outputs the graph and parameters of the graph. The graph may be a dot, a line, a circle, a ring, an arc, etc. In step S7, the parameter estimating unit 17 compares the parameters of the graph with corresponding predetermined parameters to determine whether the parameters of the graph meet predetermined requirements, such as whether a diameter of a circle is in a predetermined tolerance. In step S8, the parameter estimating unit 17 compares the parameters of the graph with parameters of a corresponding standard graph to determine whether the graph is the same as or similar with the standard graph.

FIG. 4 is a detailed description of step S3 in FIG. 3, namely obtaining gray values of various pixels of the image. In step S31, the parameter setting unit 12 sets a two-dimensional reference frame for the two-dimensional image, and sets the number of pixels whose gray values need to be obtained. In step S32, the gray value obtaining unit 13 obtains coordinates of a beginning pixel. The beginning pixel can be set manually or automatically. In step S33, the gray value obtaining unit 13 selects an algorithmic method to obtain the gray values of the pixels according to predetermined requirements or user demands. The algorithmic method may be a direct method, a median method or an average value method. Taking obtaining the gray value of the beginning pixel for example, the direct method mainly includes the steps of: (a) obtaining the two-dimensional coordinates of the beginning pixel; and (b) obtaining the gray value of the beginning pixel directly according to the two-dimensional coordinates. The median method mainly includes the steps of: (a) obtaining the two-dimensional coordinates of the beginning pixel; (b) ascertaining a neighborhood of the beginning pixel according to the two-dimensional coordinates; (c) obtaining two-dimensional coordinates of each pixel in the neighborhood; (d) obtaining a gray value of each pixel according to its two-dimensional coordinates; and (e) considering the median of gray values of all pixels in the neighborhood as the gray value of the beginning pixel. The average value method mainly includes the steps of: (a) obtaining the two-dimensional coordinates of the beginning pixel; (b) ascertaining a neighborhood of the beginning pixel according to the two-dimensional coordinates; (c) obtaining two-dimensional coordinates of each pixel in the neighborhood; (d) obtaining a gray value of each pixel according to its two-dimensional coordinates; and (e) considering the average value of gray values of all pixels in the neighborhood as the gray value of the beginning pixel. Gray values of other pixels can be obtained according to any one of the above three methods as well. In step 34, the gray value obtaining unit 13 obtains the gray value of the beginning pixel and sets the beginning pixel as a base pixel. In step S35, the gray value obtaining unit 13 obtains coordinates and a gray value of a second pixel in the neighborhood of the base pixel. In step S36, the gray value obtaining unit 13 sets the second pixel as the base pixel. In step S37, the parameter estimating unit 17 determines whether the number of pixels whose gray values have been obtained meets predetermined requirements. If the number of pixels whose gray values have been obtained meets the requirements, the procedure ends. Otherwise, the procedure returns to step S35 described above.

FIG. 5 is a detailed description of step S4 in FIG. 3, namely obtaining special pixels of the image by calculating gray grads of corresponding pixels according to respective gray values. In step S41, the parameter setting unit 12 sets a maximum gray grads for all the pixels, and sets the number of special pixels to be obtained. In step S42, the gray value obtaining unit 13 obtains a pixel and calculates its gray grads according to the steps of: (a) obtaining another pixel along a certain direction in the neighborhood of the pixel and its gray value; (b) calculating a difference of the gray values of the two pixels; (c) considering the difference as the gray grads of the pixel along the direction. In step S43, the parameter estimating unit 17 determines whether the gray grads of the pixel exceeds the maximum gray grads. If the gray grads does not exceed the maximum gray grads, the procedure returns to step S42 described above. Otherwise, if the gray grads exceeds the maximum gray grads, in step S44, the special pixel obtaining unit 14 considers the pixel as a special pixel. In step S45, the parameter estimating unit 17 determines whether the number of special pixels obtained meets predetermined requirements. If the number of special pixels obtained meets the predetermined requirements, the procedure ends. Otherwise, if the number of special pixels obtained does not meet the predetermined requirements, the procedure returns to step S42 described above.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for analyzing and processing two-dimensional images comprising a computer, the computer comprising:
an image accessing unit for accessing a two-dimensional image of an object from a storage;
a gray value obtaining unit for obtaining gray values of pixels of the two-dimensional image;
a special pixel obtaining unit for obtaining special pixels of the two-dimensional image through calculating gray grads of pixels according to respective gray values;
a graph analyzing unit for generating a graph according to the special pixels; and
an outputting unit for outputting the graph and parameters of the graph.

2. The system according to claim 1, further comprising:
a photography device for taking photographs of the object and obtaining two-dimensional image data of the object; and
an image card for transforming the two-dimensional data obtained by the photography device to an two-dimensional image which can be identified by the computer.

3. The system according to claim 1, wherein the computer further comprises a parameter setting unit for setting corresponding parameters needed for analyzing and processing the two-dimensional image.

4. The system according to claim 1, wherein the computer further comprises a parameter estimating unit for determining whether the parameters of the graph meet predetermined requirements.

5. A computer-based method for analyzing and processing two-dimensional images, the method comprising the steps of:
reading a two-dimensional image of an object from a storage;
obtaining gray values of pixels of the two-dimensional image;
calculating gray grads of the pixels to obtain special pixels of the two-dimensional image;
generating a graph according to the special pixels; and
outputting the graph and parameters of the graph.

6. The method according to claim 5, wherein the step of obtaining gray values of pixels of the image comprises the steps of:
setting the number of pixels whose gray values need to be obtained;
setting a beginning pixel in the image;
obtaining a gray value of the beginning pixel and setting the beginning pixel as a base pixel;
obtaining a gray value of a second pixel in the neighborhood of the base pixel;
setting the second pixel as the base pixel; and
repeating the last two steps to obtain gray values of other pixels of the image if the number of pixels whose gray values have been obtained dose not meet the set number requirement.

7. The method according to claim 5, wherein the step of calculating gray grads of the pixels to obtain special pixels of the image comprises the steps of:
setting a maximum gray grads for all the pixels;
obtaining a first pixel and its gray value;
obtaining a second pixel along a certain direction in the neighborhood of the first pixel and its gray value;
calculating a difference of the gray values of the two pixels as the gray grads of the first pixel;
considering the fist pixel as a special pixel, if the gray grads exceeds the maximum gray grads; and
repeating from the second step to obtain other special pixels of the image if the number of special pixels obtained does not meet a predetermined number requirement.

8. The method according to claim 7, further comprising the step of:
setting the number of special pixels to be obtained.

9. The method according to claim 5, further comprising the step of:
comparing the parameters of the graph with predetermined parameters to determine whether the parameters of the graph meet the predetermined requirements.

10. The method according to claim 5, further comprising the step of:
comparing the parameters of the graph with parameters of a corresponding standard graph to determine whether the graph is the same as or similar with the standard graph.

11. The method according to claim 5, wherein the graph is any one of a dot, a line, a circle, a ring, an arc and a circular arc.
